(19) United States
(12) Patent Application Publication
(10) Pub. No.: US 2007/0184856 A1
(43) Pub. Date: Aug. 9, 2007

(54) Choice-based short messaging service in wireless networks and devices therefor

(76) Inventors: Narendranath Kudlu, Bangalore (IN); Bino Sebastian, Bangalore (IN)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/348,510

(22) Filed: Feb. 6, 2006

(51) Int. Cl. H04Q 7/20

(52) U.S. Cl. 455/466

(57) ABSTRACT

A method and apparatus for transmitting and receiving choice-based short messages are disclosed.

### BACKGROUND AND SUMMARY

Mobile telephones and mobile data processing devices, such as personal digital assistants (PDAs), portable computers, text messaging devices, and the like, continue to gain in popularity and usage. Indeed, as the number of applications for these devices continues to increase, the lines of demarcation between mobile telephone and PDA become less distinct and indeed several combination, or hybrid, mobile devices exist. Mobile devices, including mobile telephones, are now capable of taking and storing photographs and video, browsing the Internet, playing music, downloading files, receiving and displaying e-mail messages including file attachments, to name just some functions.

One type of mobile communication is known as short messaging service (SMS). Short messaging service generally involves the transmission of comparatively short alphanumeric messages between a message handling system and a mobile device. Normally, SMS is carried out over control channels, thus not interfering with data transmission in a wireless system. Although short messages were originally primarily for paging purposes, various additional applications, including interactive questioning, stock quotations, and weather, traffic, news, and sports broadcasting are becoming more common.

While known SMS methods provide a rather straight-forward vehicle to convey information, there are drawbacks to these known methods. For example, SMS may be used to convey a choice-based question or query to an audience. Under known methods, the question(s) require the respondent to provide the exact text of the selected choice. If the respondent does not recall the exact choice or inadvertently mis-types the response, the answer is not recognized. Moreover, such known methods are not user-friendly, requiring significant input by the respondent.

There is a need, therefore, for a choice-based SMS method and apparatus that overcomes at least the shortcomings of known methods described above.

In accordance with an example embodiment, a method of transmitting short messages includes transmitting a choice-based short messaging system (SMS) signal including a transfer protocol-protocol identifier (TP-PID); receiving the TP-PID; and decoding the TP-PID to provide questions and choices.

In accordance with another example embodiment, a wireless network adapted to send and receive short messages, includes at least two short message entities (SMEs) adapted to transmit and receive choice-based short message service (SMS) signals including a transfer protocol identifier (TP-PID).

In accordance with another example embodiment, a short message entity (SME) includes a transmitter adapted to transmit short message service (SMS) signals. The SME also includes a receiver adapted to receive SMS signals; a controller adapted to decode a choice-based transmit protocol-protocol identifier (TP-PID); and a display adapted to provide a choice-based SMS message.

### BRIEF DESCRIPTION OF THE DRAWINGS

The example embodiments are best understood from the following detailed description when read with the accompanying drawing figures. Wherever applicable and practical, like reference numerals refer to like elements.

FIG. 1 is a simplified block diagram of a wireless network in accordance with an example embodiment.

FIG. 2 is a simplified block diagram of a device for reception and transmission of SMS in accordance with an example embodiment.

FIG. 3 is a conceptual diagram of the SMS protocol layers in accordance with an example embodiment.

FIG. 4 is a conceptual diagram of a transfer protocol data unit (TPDU) in accordance with an example embodiment.

FIG. 5 is a conceptual diagram of an SMS-deliver TPDU in accordance with an example embodiment.

FIG. 6 is a flow-chart of a method of receiving a choice-based SMS and providing a reply in accordance with an example embodiment.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

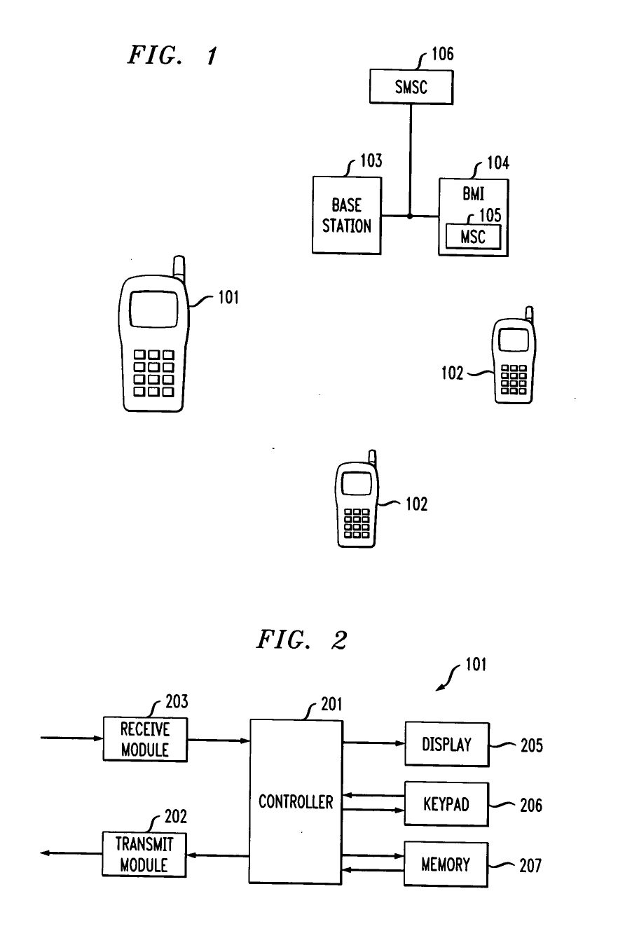

FIG. 1 is a conceptual view of a wireless network in accordance with an example embodiment. The network includes a short message entity (SME) 101. Illustratively, the SME 101 is a wireless station such as a mobile telephone, a mobile data processing device (e.g., portable computer) or a stationary device in a wireless network. The SME 101 transmits signals to and receives signals from a base site or base station 103. The base station 103 can be a part of a wireless network comprising a Base Station/Mobile Switching Center/Interworking function (BMI) 104 that includes a mobile switching center (MSC) 105 and a Short Message Service Center (SMSC) 106 or SC. The MSC 105 is optional and provides a connection to landline trunks. In operation, the SME 101 communicates with other SMEs 102 according to a short message protocol of an example embodiment.

Notably, the wireless network may be a time division/multiple access (TDMA) network or a code division/multiple access (CDMA) system. The SMEs 101,102 are adapted to operate in accordance with a number of other standards such as GSM. It is emphasized that the noted protocols are merely illustrative and are in no way limiting of the applications of the example embodiments.

The SMSC 106 comprises two main functional blocks: a short message service center database block; and a short message gateway/interworking block (SMS-IWMSC). The database block is used for storing short messages as well as for storing a database of subscribers. The gateway/interworking block provides the interface between the SMSC to a GSM network and delivers the short messages to the recipient.

The SMSC 106 is arranged to interface SMEs 101, 102 accessing the network. The SMSC 106 provides access to the SMEs 101, 102 through a uniform Short Message Client Interface (SMCI) based on TCP/IP. The SMSC 106 stores messages from the SMEs and dispatches the information to destination SMEs according to a destination address.

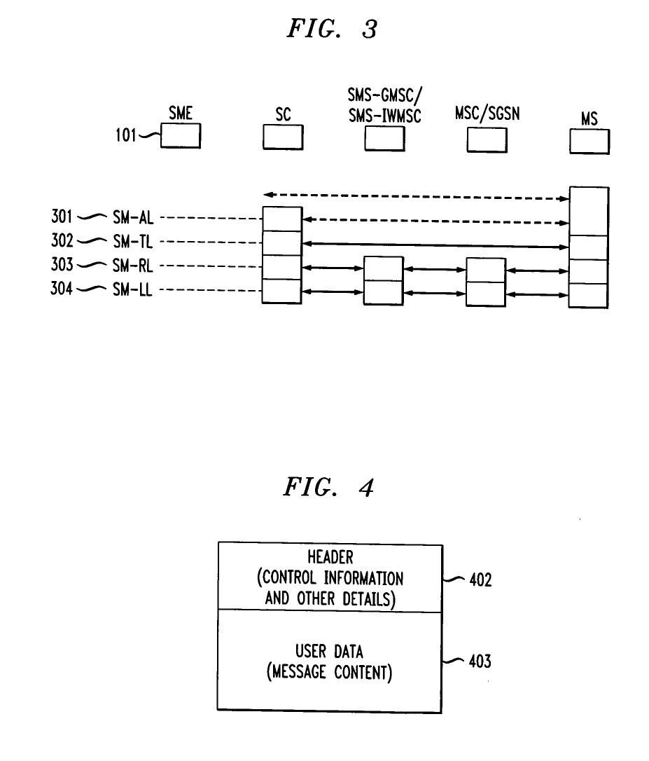

FIG. 2 is a simplified block diagram of the SME 101. The components of SME 101 may also be included in SMEs 102. The SME 101 includes a controller 201, a transmit module(transmitter) 202, a receiver module (receiver) 203. The controller 201 includes software and is adapted to provide signals to and receive signals from the transmit module 202 and receive module 203, respectively. These signals include signaling information in accordance with the applicable wireless network, and also user speech and/or user generated data, such as SMS data.

The controller 201 may be a microprocessor, processor or microcontroller typically found in a wireless communication device. A software module (not shown) is included in the controller for implementing certain functions such as the audio (speech path) and logic functions of the SME 101.

A user interface includes a display 205 and a keypad 206, which are coupled to the controller 201. The keypad 205 includes alphanumeric (0-9, ABC, etc.) keys and related keys (e.g., #,*), and other keys used for operating the device 101. These other keys may include, by example, a SEND key, various menu scrolling and soft keys, and a power key.

The device 101 also includes various memories, shown collectively as the memory 207. The memory 207 stores a plurality of constants and variables that are used by the controller 201 during the operation of the SME 101. For example, the memory 207 stores the values of wireless system parameters. The memory 207 also includes an operating program (software) adapted to control the controller 205. The operating program in the memory 207 includes routines to present messages and message-related functions to the user on the display 208, typically as various menu items. The memory 207 may also store data including point-to-point and broadcast SMS messages that are received from the SMSC 106 prior to the display of the messages for the user, as well as SMS messages composed by the user prior to transmission to the SMSC 106. In an example embodiment, the memory 207 is a read-only memory (ROM) device.

Transmission and reception of short messages of example embodiments may be provided by a protocol layered structure set forth by the GSM standard ETSI/3GPP, the disclosure of which is specifically incorporated herein by reference. A conceptual diagram of the protocol layered structure is shown in FIG. 3. The protocol layers include a short message application layer, SM-AL 301 as the top layer in the stack. A short-message transfer layer, SM-TL 302 is the next layer; a short-message relay layer, SM-RL 303 is the next layer; and a short-message lower layer, SM-LL 304 is the bottom layer of the stack. Shown conceptually above the protocol layers in FIG. 3 are the SMS gateway mobile switching center (SMS-GMSC)/SMS-IWMSC; the MSC, the SC and the MS.

Transmission of a choice-based SMS according to example embodiments is best understood through a review of FIG. 3. The user enters the questions/queries into the SME 101 via the user interface components 205,206. The SM-AL 301 then encodes this message with the questions along with the TP-PID of the choice based SMS. The SM-AL also includes an identifier for the message that is transmitted. The user interface (e.g., keypad 206) is connected to the SM-AL 301 via the controller 205 of the SME 101. The SM-AL 301 encodes the message for transmission to the SM-TL 302 and then to the SMSC 106 of the system.

Messages transmitted are transmitted between SMEs in packets referred to as transfer protocol data units (TPDUs). The TPDUs are known from the SMS protocol referred to previously. FIG. 4 is a conceptual diagram of a TPDU 400 in accordance with an example embodiment. The TPDU 400 includes a header field 401 and a user data field 402. The header field 401 includes, among other information, an identification of the SME transmitting the message and an identification of the intended recipients. The user data field 402 may include the data for the message.

In a specific embodiment, for each SMS there are six TPDUs: the SMS-deliver TPDU includes the message received by the SME; the SMS-deliver-report TPDU includes an acknowledgement (ACK) message sent by the receiving SME indicating receipt of the message; the SMS-submit TPDU includes the message sent by an SME to the SMSC; the SMS-submit-report TPDU includes an acknowledgement of the sending of a message by an SME; the SMS-status-report includes a status of an SMS and is provided by the SMSC to the transmitting SME; and the SMS-command TPDU includes the command fields from the SME to the SMSC. For example destination addresses are included in the SMS-command TPDU.

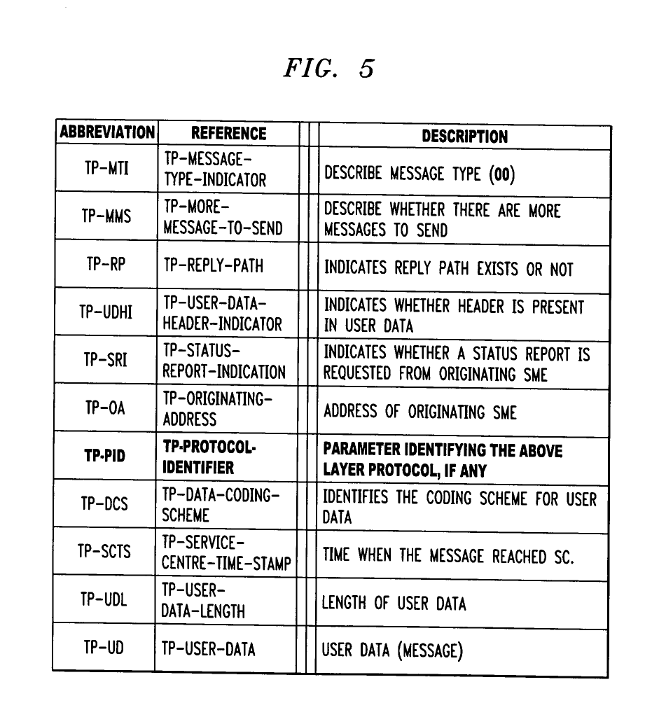

FIG. 5 is a conceptual diagram of an SMS-deliver TPDU in accordance with an illustrative embodiment. The SMS-deliver TPDU of the example embodiment includes a transfer protocol-protocol identifier (TP-PID). The TP-PID is the information element by which the SM-TL either refers to the higher layer protocol being used, or indicates inter-working with a particular type of device. This is a single byte field. If a receiving SME is not able to interpret the TP-PID, the TP-PID is ignored and the SMS signal is processed according to the known protocol. However, if the SME is able to interpret the protocol involved using the TP-PID and application for this protocol exists in the controller of the SME then the message is handled as per the protocol.

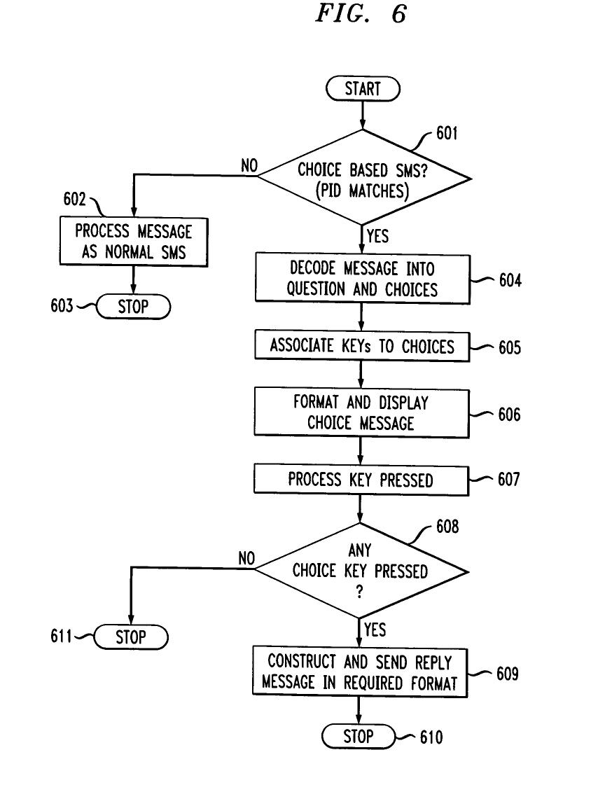

Reception via the SMS protocol of the example embodiments is understood through a review of the method of FIG. 6. At the receive-side SME (e.g., SME 102), the message is received at the peer SM-TL of the SME 102. The SM-TL of the receiving SME 102 transfers the message to a peer SM-AL of the SME 102. At step 601, the SM-AL determines if the TP-PID of the TPDU matches that of a choice-based SMS. If there is a match, the SME 101 can process the SMS as a choice-based SMS of the example embodiments. If there is no match, the SMS signal is processed as an already known type of SMS at step 602 and the sequence terminates at step 603.

If the choice-based SMS protocol is supported, the method continues at step 604. At this step, the message is decoded at the SM-AL into questions and choices. At step 605, the decoded data are provided to the controller of the SME, which sets the user interface (display and keys) for according to the choice-based SMS received. Notably, the choices are associated with respective keys by the controller as set forth in the protocol.

At step 606, the controller sets the display to provide the choice-based message. At step 607, the selected keys are engaged by the user. At step 608, the method includes decision. If a choice is pressed, the controller, via the interface, constructs an SMS according to the choice-based protocol of the example embodiment. To wit, the controller provides a TPDU including a TP-PID with the information on the choice selected along with the identifier of the original message received. The controller provides the TPDU to the SM-AL layer and then to the SM-TL layer. The reply TPDU is transmitted to the SMSC for transmission to the originating SME. At this point, the message is transmitted and the process terminates at step 609.

The SME 101 receives the reply TPDU from SME 102 and decodes the reply. From the message identifier it is identified that the reply is for a particular choice-based SMS sent to SME 102. The choice made is also decoded from the reply.

An example highlighting the features of the method and apparatus of the example embodiments is provided. It is emphasized that this example is merely illustrative and in no way limiting of the embodiments.

The initiator/originator SME decides to set the TP-PID field of the TPDU with the value that is selected for Choice based SMS. An SME that does not include the choice-based protocol to interpret this TP-PID will handle message exactly the same way as explained in connection with the method of FIG. 6. If the SME includes the choice-based SMS protocol, then the message is displayed per this example.

The SME receives the TPDU having the TP-PID containing the message below in the user data field. The controller 201 then provides the message to the display 205:

This is a choice based SMS, to reply with your choice press the key associated with the choice in the display; to discard the message press <KEY #>

What is your current car?

A) Ford - - - <KEY 1>

B) Honda - - - <KEY 2>

C) Toyota - - - <KEY 3>

D) None of the above - - - <KEY 4>

If mobile user presses <KEY 1> choice A is sent as the response. If mobile user presses <KEY 2> choice B is sent as the response. If mobile user presses <KEY 3> choice C is sent as the response. If mobile user presses <KEY 4> choice D is sent as the response. If mobile user presses <KEY #> the message is discarded and no response is sent back.

The originator will consider the reply that is received and match the question to the answer and know exactly which number has “voted”.

In accordance with illustrative embodiments described, a method of transmitting and receiving choice-based SMS messages from mobile devices is disclosed. One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

We claim:

1. A method of transmitting short messages, comprising:
transmitting a choice-based short messaging system (SMS) signal including a transfer protocol-protocol identifier (TP-PID);
receiving the TP-PID;
decoding the TP-PID to provide questions and choices.

2. A method as recited in claim 1, further comprising, after the decoding, associating keys of a short message entity (SME) with the choices.

3. A method as recited in claim 2, wherein the SME is a device adapted to transmit and receive short messages.

4. A method as recited in claim 1, wherein the transmitting further comprises:
transmitting the choice-based SMS signal to a short message service center (SMSC); and
transmitting the choice-based SMS signal to a short message entity (SME).

5. A method as recited in claim 2, wherein the method further comprises, after the associating, formatting and displaying choice-based message on the SME.

6. A method as recited in claim 1, further comprising, constructing and transmitting a reply message along with another TP-PID.

7. A wireless network adapted to send and receive short messages, comprising:
at least two short message entities (SMEs) adapted to transmit and receive choice-based short message service (SMS) signals including a transfer protocol identifier (TP-PID).

8. A wireless network as recited in claim 7, wherein the SMEs are adapted to decode the TP-PIDs.

9. A wireless network as recited in claim 7, further comprising a short message service center (SMSC) adapted to receive the choice-based SMS signals from the SMEs and to transmit the choice-based SMS signals to the SMEs.

10. A wireless network as recited in claim 1, wherein the SMEs are one or more of: wireless telephones, personal digital assistants (PDAs), portable computers and text messaging devices.

11. A wireless network as recited in claim 8, wherein the SMEs are adapted to decode the TP-PIDs into questions and choices.

12. A wireless network as recited in claim 11, wherein the SMEs include keys and the SMEs are adapted to associate the keys with the choices.

13. A wireless network as recited in claim 12, wherein the SMEs are adapted to format and display a choice-based message from the decoded TP-PIDs.

14. A short message entity (SME), comprising:
A transmitter adapted to transmit short message service (SMS) signals;
A receiver adapted to receive SMS signals;
A controller adapted to decode a choice-based transmit protocol-protocol identifier (TP-PID); and
A display adapted to provide a choice-based SMS message.

15. An SME as recited in claim 14, further comprising an interface adapted to select a choice provided on the display.

16. An SME as recited in claim 15, wherein the interface is a keypad connected to the controller.

17. An SME as recited in claim 14, wherein the SME is one of: a wireless telephone, a personal digital assistant (PDA), a portable computers and a text messaging device.
